(19) United States
(12) Patent Application Publication
(10) Pub. No.: US 2007/0005466 A1
(43) Pub. Date: Jan. 4, 2007

(54) Systems and methods for managing a financial account that provides intangible rewards

(75) Inventors: Charles Rosenblatt, Richmond, VA (US); Emil Phillips, Chesterfield, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corp.

(21) Appl. No.: 11/170,169

(22) Filed: Jun. 30, 2005

(51) Int. Cl. G07G 1/14; G06Q 40/00; G06Q 30/00

(52) U.S. Cl. 705/35; 705/14

(57) ABSTRACT

Methods, systems, and articles of manufacture consistent with embodiments of the present invention may receive information associated with providing an intangible reward from a vendor to a customer when the customer has a payment provider make a payment to the vendor, such as on a recurring basis.

### BACKGROUND

1. Technical Field

Embodiments consistent with the present invention generally relate to methods and systems for managing a financial account and, more particularly, to managing a financial account that provides intangible rewards.

2. Related Art

Credit card companies, and other financial account issuers, sometimes provide awards to their members for using their credit cards. For example, the companies may advertise that they will provide a cash back award to a cardholder every time he makes a purchase using the companies' credit card. Alternatively, they may provide a point redemption system, whereby the credit card holder earns points for using his credit card and may redeem a product from the credit card company when he earns enough points (e.g., mileage points for airline tickets). Such award systems, however, may be expensive for the credit card company because they provide tangible awards and/or may be difficult to administer.

Accordingly, it would be beneficial to provide a system and method of providing intangible rewards.

### SUMMARY OF EXEMPLARY EMBODIMENTS

Consistent with embodiments of the present invention, systems and methods disclosed may provide an intangible reward to a customer.

One exemplary embodiment of the invention relates to a method that includes receiving information associated with providing an intangible reward from a vendor to a customer when the customer has a payment provider make a payment to the vendor on a recurring basis.

Another exemplary embodiment of the invention relates to a system that includes a memory and a processor. The memory and the processor may be configured to receive information associated with providing an intangible reward from a vendor to a customer when the customer has a payment provider make a payment to the vendor on a recurring basis.

Another exemplary embodiment of the invention relates to a computer-readable medium. The computer-readable medium may contain instructions to configure a computer to receive information associated with providing an intangible reward from a vendor to a customer when the customer has a payment provider make a payment to the vendor on a recurring basis.

Another exemplary embodiment of the invention relates to another method. The method may include configuring a customer's financial account for association with an intangible reward, and receiving information associated with providing the intangible reward from a vendor to a customer when the customer uses the financial account to make a payment to the vendor.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this specification, illustrate several embodiments of the invention and together with the description, serve to explain principles of the invention. In the drawings:

FIG. 1 illustrates an exemplary system consistent with an embodiment of the invention;

FIG. 2 illustrates an exemplary method consistent with an embodiment of the invention;

FIG. 3 illustrates an exemplary web page consistent with an embodiment of the invention; and

FIG. 4 illustrates another exemplary web page consistent with an embodiment of the invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Consistent with one embodiment of the present invention, systems and methods for providing intangible rewards are described. As discussed herein, intangible rewards are rewards that are not physical products or goods or services. Instead, intangible rewards may be, for example, special features of products or services, virtual rewards, or other rewards that are not material things or services. Virtual rewards are computer-simulated rewards, such as computer-simulated items in a computer game.

As described below, systems consistent with one embodiment of the invention may provide an intangible reward to a customer when a customer uses a financial account to make a purchase transaction with a vendor. In one exemplary embodiment, a customer may receive an intangible award when the customer uses the financial account to make payment from a payment provider on a recurring basis for products or services purchased from a vendor. A payment provider may be any person, entity, or thing used by a customer to pay a vendor for purchased products or services. Payment providers may include credit card companies, charge card companies, banks, e-commerce payment companies (e.g., PayPal from eBay, Inc. of San Jose, Calif.), etc. The system may allow the customer to purchase a product or service from the vendor and set up the payment provider to make payments on a recurring basis to the vendor for the product or service. Payments on a recurring basis may include regular (e.g., daily, monthly, weekly, yearly, etc.) payments, irregular payments, repeated payments, subscription payments (e.g., monthly subscription payments for an online service), payments for a one-time service or product, payments for a continuing service or product, or payments made more than once for services or products.

The system may allow the vendor to provide an intangible reward to the customer for using the payment provider to make a payment, such as recurring payments for the vendor's product or service. The vendor may be any person, entity, or thing, such as a merchant, that sells a product or service. For example, the vendor may be an online game provider, an online movie rental site, a utility company, or an internet service provider. A product may be any tangible item, and a service may be any work, action, or benefit available for purchase. Products may include merchandise, goods (e.g., computer games), property, etc. Services may include subscriptions (e.g., online movie rental subscriptions), contracted work, actions, etc.

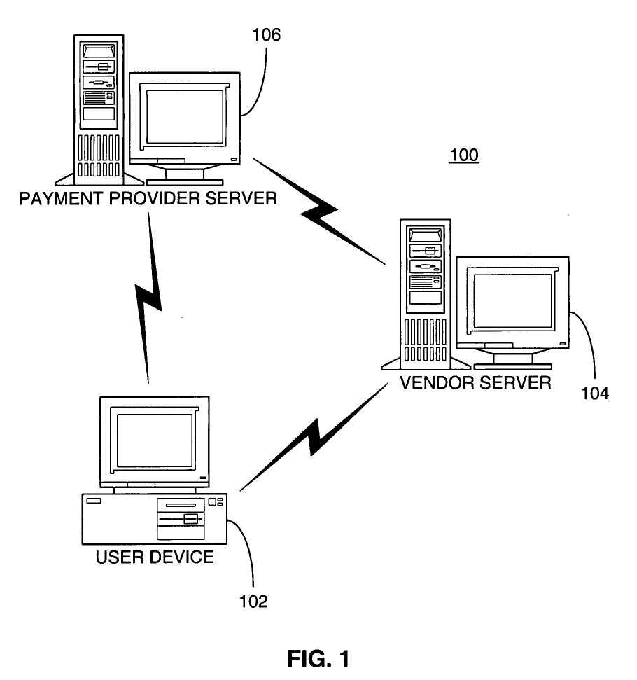

In one embodiment consistent with the invention, the system may include a component for purchasing a product or service or for configuring payment for the product or service, a component for providing the product or service, and, in exemplary embodiments, a component for making payments on a recurring basis. These components may be implemented in a system such as system 100 of FIG. 1. Any suitable combination of hardware, software, and/or firmware may be used to implement the components. The hardware, software, and/or firmware may include processors, memory, storage devices, computer-readable mediums, external communication devices, internal communication devices, etc. The aforementioned system 100 is exemplary and other systems may include the components, consistent with embodiments of the present invention.

By way of a non-limiting example, FIG. 1 illustrates an exemplary system 100 consistent with one embodiment of the invention. As shown in FIG. 1, exemplary system 100 may include a user device 102, a vendor server 104, and a payment provider server 106. User device 102, vendor server 104, and payment provider server 106 may communicate over a network, a wireless communication channel, or any other mechanism or combination of mechanisms (not shown) for conveying information between locations. A network may be a single network or combination of networks, and may include a local area network, a wide area network, an intranet, an extranet, the Internet, a telephone network, a wired network, a wireless network, a postal network, or any other medium for communicating between locations.

User device 102 may allow a customer to purchase products or services from a vendor. Further, user device 102 may allow the customer to set up a payment method for the products and services or reconfigure the payment method of previously purchased products and services. User device 102 may include a computer, client station, gaming system, kiosk, web browser, portable digital assistant, credit card machine, or any other mechanism that allows the customer to configure the payment method for products and services. For example, user device 102 may allow a customer to access a web page provided by vendor server 104. Through the web page, the customer may select a payment method and choose to pay for a product or service from a vendor associated with vendor server 104. For instance, the customer may choose to pay the vendor with a credit card on a recurring monthly basis for a monthly subscription service.

Vendor server 104 may allow a customer to select products or services for purchase. A vendor associated with vendor server 104 may provide the product or service over vendor server 104 or may provide the product or service via other channels. Depending on the payment method, the vendor may provide intangible rewards to the customer over vendor server 104 or other channels. Vendor server 104 may be a computer, a server, a mainframe, or any other mechanism used by the vendor to make products and services available for purchase. For example, vendor server 104 may store a web page accessible by potential customers for purchasing the vendor's products and services, and may receive information from user device 102 authorizing the vendor to receive payments on a recurring basis for the purchased products and services.

Payment provider server 106 may provide payment for products and services purchased from a vendor. In one embodiment, the payment provider is an issuer of a financial account, such as a credit card, issued to the customer for making payments to vendors for products and services. Payment provider server 106 may make the payments to the vendor via vendor server 104 or other channels. Payment provider server 106 may make the payments according to a payment method selected by a customer via user device 102. In exemplary embodiments, the payment method used by the customer may include making credit card payments on a recurring basis. For example, payment provider server 106 may receive information from user device 102 and/or vendor server 104 instructing the customer's credit card company to make monthly credit card payments to a vendor.

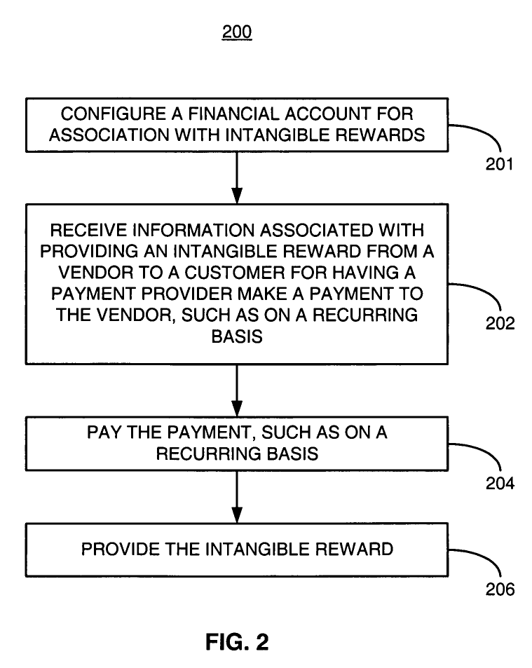

FIG. 2 illustrates an exemplary method 200 consistent with one embodiment of the present invention for managing a financial account that provides intangible rewards. In one embodiment, system 100 may implement method 200, in part or in its entirety. By way of illustration, system 100 may configure a customer's financial account for association with intangible rewards (stage 201). Configuring the financial account may include associating the account with information about intangible rewards from vendors. As a result, when a customer uses the account at a vendor, system 100 may automatically detect that the customer is using an account that is eligible for intangible rewards. This may then allow the vendor to provide the intangible rewards automatically.

System 100 may receive reward information associated with a vendor providing an intangible reward to a customer when the customer uses the financial account to make payment for a product or service offered by the vendor (stage 202). In exemplary embodiments, the intangible reward is provided when the customer uses the financial account to make payment (e.g., via the payment provider) to the vendor on a recurring basis. The received information may be received by one of user device 102, vendor server 104, and payment provider server 106, or any combination thereof. System 100 may also distribute the received information to a component (not shown) external to system 100 for processing.

System 100 may use the received information to set up the payment to be paid, such as on a recurring basis to the vendor (stage 204). For example, system 100 may have a payment provider pay the payment on the recurring basis. In this regard, payment provider server 106 may electronically pay the payment for the payment provider. The payment provider may make the payment according to a payment method specified in the received information. For example, the payment provider may pay the payment by a payment due date using the customer's financial account (e.g., charging the payment to a credit card account, withdrawing the payment from a checking account, etc.) as specified in the information received at processing stage 202.

System 100 may have the vendor provide an intangible reward to the customer upon using the financial account to make payment (stage 206). As described above, in exemplary embodiments, system 100 may have the vendor provide the intangible reward when the customer has the payment provider make payment to the vendor on a recurring basis. Providing the intangible reward may include communicating to a person, entity, or thing to initiate provision of the intangible reward. Vendor server 104 may provide the intangible reward by configuring software to enable a feature of a product or service for the customer. The intangible reward may be provided upon the customer purchasing a product or service and selecting a payment method, or, for example, the vendor receiving the first, second, or subsequent payment of a series of recurring payments. The intangible reward may only be available to the customer if, for example, the customer has the payment provider make the payment on the recurring basis to the vendor. In another example, the intangible reward may only be available to customers that purchase a product or service from a vendor using a specific brand of credit card (e.g., a Capital One credit card from Capital One Financial Corp. of McLean, Va.) and not other credit cards.

The intangible reward may be a feature of a product or a feature of a service provided by the vendor. The feature may also be for the product or service purchased by the customer. For example, if a customer purchases a cellular phone and sets up his Capital One credit card to pay the monthly subscription charges for the cellular phone, then he may receive additional ring tones and screen savers on the cellular phone.

Different intangible rewards may be available for different situations. The available intangible rewards may, for example, be a function of the amount of the payment made, how often the payment is made, or how long the payment is made, on a recurring basis. For instance, if a customer purchases a two year cellular phone service and sets up his Capital One credit card to pay the monthly subscription charges for the cellular phone, then he may receive 10 extra ring tones on the cellular phone. But, if the customer purchases a one year cellular phone service and sets up his Capital One credit card to pay the monthly subscription charges for the cellular phone, then he may only receive one extra ring tone on the cellular phone.

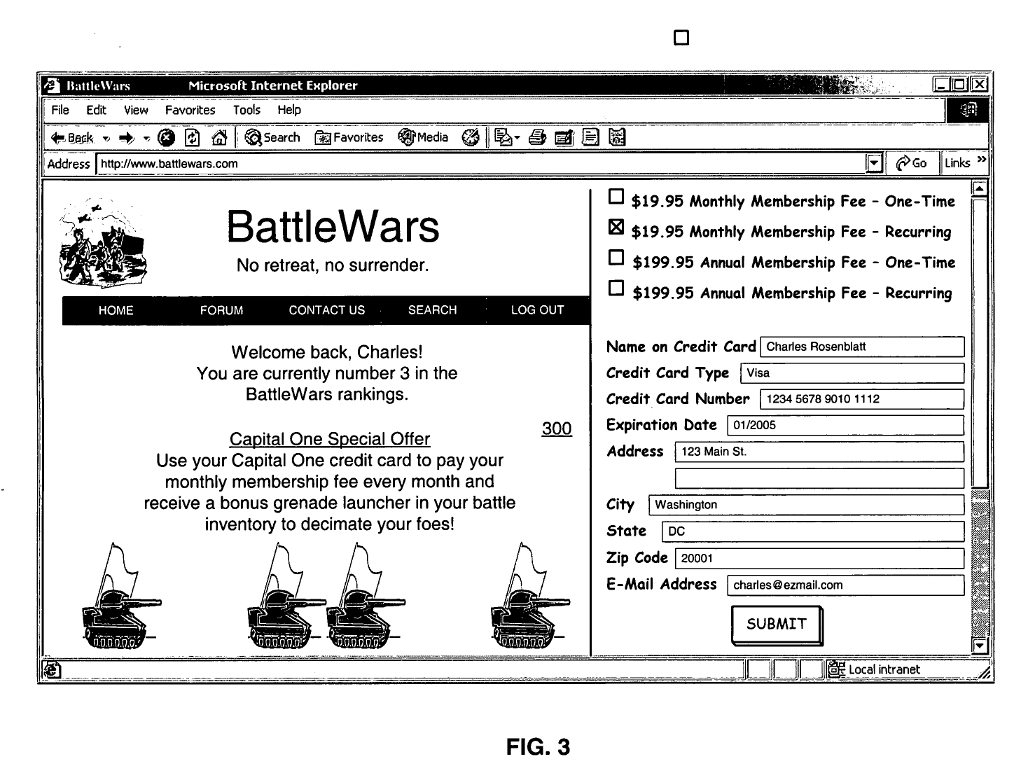

FIG. 3 illustrates an exemplary web page 300, consistent with one embodiment of the invention, through which customers may purchase products or services from a vendor and set up a payment method for the products. The customers may receive intangible rewards according to the payment method selected for the purchased products or services. Web page 300 may be stored on vendor server 104 in FIG. 1. Customers may use user device 102 to access web page 300 on vendor server 104.

For example, as illustrated in FIG. 3, a customer may subscribe to an online computer game. The monthly subscription fee may be $19.99. Using user device 102 to access web page 300 on vendor server 104, the customer may login to his online computer game account. Web page 300 may provide an advertisement to the customer, indicating that if the customer chooses to use his Capital One credit card to pay his monthly subscription fee on a recurring basis, then he will receive a virtual reward, which in this example is a special grenade launcher available only to subscribers that use their Capital One credit cards to pay their monthly subscription fee on a recurring basis.

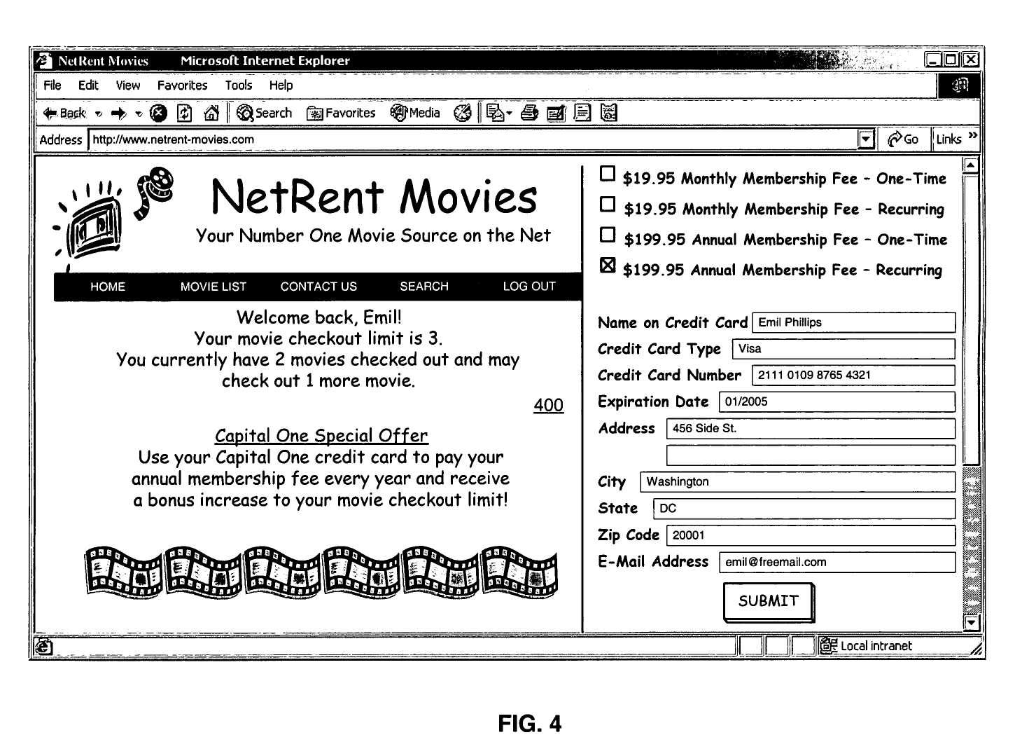

FIG. 4 illustrates another exemplary web page 400, consistent with on embodiment of the invention, through which customers may purchase products or services from a vendor and to set up a payment method for the products. As shown in FIG. 4, a customer may subscribe to an online movie rental service. Using user device 102 to access web page 300 on vendor server 104, the customer may login to his online movie rental account. The customer may normally only be able to have three movies checked out before he needs to return a movie to check out another movie. Web page 400 may provide a promotion to the customer, indicating that if the customer chooses to use his Capital One credit card to pay his annual subscription fee on a recurring basis, then his movie checkout limit will be increased to four movies.

By way of further example, a customer may subscribe to an online internet provider. The online internet provider might provide a special instant messaging feature (e.g., the intangible reward) to the customer, if the customer elects to have a payment provider pay the subscription fee on a recurring basis to the internet service provider.

Additionally, a customer may subscribe to a massive multi-player online game (MMOG) service. The vendor providing the MMOG may offer special game weapons for use in the MMOG if the customer elects to have a payment provider pay the subscription fee on a recurring basis to the vendor.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A system comprising:
a memory; and
a processor,
wherein the memory and the processor are configured to perform a method comprising receiving information associated with providing an intangible reward from a vendor to a customer when the customer has a payment provider make a payment to the vendor on a recurring basis.

2. The system of claim 1, wherein the intangible reward is a virtual reward.

3. The system of claim 1, wherein the intangible reward is only available to the customer if the customer has the payment provider make the payment to the vendor on the recurring basis.

4. The system of claim 1, wherein the intangible reward is a feature of a product or a feature of a service provided by the vendor.

5. The system of claim 1, wherein different intangible rewards are available for different recurring payment bases.

6. The system of claim 1, wherein the method further comprises configuring, on the basis of the received information, the payment to occur on the recurring basis.

7. The system of claim 1, wherein the method performed by the memory and processor further comprises providing the intangible reward.

8. A computer-readable medium comprising instructions to configure a computer to perform a method comprising receiving information associated with providing an intangible reward from a vendor to a customer when the customer has a payment provider make a payment to the vendor on a recurring basis.

9. The computer-readable medium of claim 8, wherein the intangible reward is a virtual reward.

10. The computer-readable medium of claim 8, wherein the intangible reward is only available to the customer if the customer has the payment provider make the payment to the vendor on the recurring basis.

11. The computer-readable medium of claim 8, wherein the intangible reward is a feature of a product or a feature of a service provided by the vendor.

12. The computer-readable medium of claim 8, wherein different intangible rewards are available for different recurring payment bases.

13. The computer-readable medium of claim 8, wherein the method further comprises:
paying the payment on the recurring basis; and
providing the intangible reward.

14. A method comprising:
receiving information associated with providing an intangible reward from a vendor to a customer when the customer has a payment provider make a payment to the vendor on a recurring basis.

15. The method of claim 14, wherein the intangible reward is a virtual reward.

16. The method of claim 14, wherein the intangible reward is only available to the customer if the customer has the payment provider make the payment to the vendor on the recurring basis.

17. The method of claim 14, wherein the intangible reward is a feature of a product or a feature of a service provided by the vendor.

18. The method of claim 14, wherein different intangible rewards are available for different recurring payment bases.

19. The method of claim 14, further comprising paying the payment on the recurring basis.

20. The method of claim 14, further comprising providing the intangible reward.

21. A method comprising:
configuring a customer's financial account for association with an intangible reward; and
receiving information associated with providing the intangible reward from a vendor to the customer when the customer uses the financial account to make a payment to the vendor on a recurring basis.

22. The method of claim 21, further comprising configuring, on the basis of the received information, the payment to occur on the recurring basis.
